(19) United States
(12) Patent Application Publication
(10) Pub. No.: US 2026/0287016 A1
(43) Pub. Date: Sep. 24, 2026

(54) Sustainable Sliding-Bearing Assembly

(71) Applicant: igus SE & CO. KG, Köln (DE)

(72) Inventors: Michael Hornung, Troisdorf (DE); Lars Fenger, Köln (DE); Stefan Niermann, Paderborn (DE)

(21) Appl. No.: 19/474,402

(22) PCT Filed: Mar. 27, 2024
(86) PCT No.: PCT/EP2024/058319

§ 371 Date: Oct. 10, 2025

(30) Foreign Application Priority Data
Apr. 13, 2023 (DE) 20 2023 101 887.4

(51) Int. Cl. F16C 29/02; F16C 33/18; F16C 33/20

(52) U.S. Cl. CPC F16C 29/02; F16C 33/18; F16C 33/20; F16C 2208/00; F16C 2212/04

(57) ABSTRACT

A sliding-bearing assembly includes a slide and a rail. The rail has a cylindrical guide portion, the cylinder axis of which runs in a longitudinal direction. The slide has a passage running in the longitudinal direction for receiving the guide portion of the rail. In an operating state of the sliding-bearing assembly, in which the slide can be moved such that it is slidably guided along the rail in the longitudinal direction, the guide portion is arranged in the passage of the slide and is enclosed by an inner face of the passage, thus fixing the slide in position perpendicularly to the longitudinal direction. In a particular operating state, the slide rests against the rail exclusively via the inner face of its passage; and the guide portion is made of wood and the inner face of the passage is made of a sliding plastic, in particular of a tribopolymer.

The invention relates to a sliding-bearing assembly according to the generic part of claim 1, as well as a system comprising such a sliding-bearing assembly, the use of such a sliding-bearing assembly, and the use of materials for implementing such a sliding-bearing assembly.

Generic sliding-bearing assemblies comprise a slide and a rail that are designed to correspond to each other. Such sliding-bearing assemblies are used to move two different components longitudinally against each other, wherein a first of these components is fastened to the slide and a second of these components is fastened to the rail. For this purpose, the rail is elongated in the longitudinal direction and has a cylindrical guide portion, the cylinder axis of which extends in the longitudinal direction. The slide has a passage corresponding to the cylindrical guide portion so that in an operating state of the sliding-bearing assembly in which the guide portion of the rail is located in the passage of the slide, the passage encloses the guide portion in such a way that the slide is fixed in its position relative to the rail in any direction perpendicular to the longitudinal direction, but can be moved in the longitudinal direction along the rail, wherein during this movement an outer face of the guide portion rests against an inner face of the passage and slides along the latter while resting against it. Usually, the rail has a longitudinal extension length which is at least 4 times, in particular at least 5 times, in particular at least 10 times the longitudinal extension length of the slide, so that the rail represents a considerable moving distance in the longitudinal direction along which the slide can be moved. The rail is often straight, so that the guide portion is designed as a straight cylinder, so that the slide is forced by the guide provided by the rail in the operating state to move in a straight line along the rail in the longitudinal direction. The cylinder can for instance have a round or angular cross-section that is constant over the entire longitudinal extension of the cylinder so that the slide can be guided uniformly on the guide portion over its longitudinal extension.

Sliding-bearing assemblies of this type are used in a wide range of applications, for example in furniture, movable display devices or in machines, for example in transport machines, measuring machines, and/or in machines for filling and packaging. An important requirement is to provide a sliding support for the slide on the rail that is as wear-free and maintenance-free as possible, durable, and low-friction. It has proven particularly desirable to design the bearing between the rail and the slide without lubricant, as this avoids unnecessary contamination and keeps the bearing as maintenance-free as possible. In the prior art, suitable material pairings of rail and slide have been developed for this purpose, with which sliding-bearing assemblies bearing have been achieved that satisfactorily meet at least the majority of the requirements mentioned. To ensure a long service life, a rail made of a metal, such as steel or stainless steel, is normally used, with which a rail with a considerable longitudinal extension can be manufactured in a standardized and cost-effective manner. Bronze or a sliding plastic has proven to be suitable for the inner face of the slide's passage, which is the sliding partner for the rail, i.e. the corresponding surface of the slide that rests against the rail during movement of the slide. A sliding plastic is a polymer material that has a low coefficient of friction compared to the material of the rail. These include in particular the thermoplastics such as polyethylene, polypropylene, polyacetal, polycarbonate, polyamide, polyvinyl chloride, polytetrafluoroethylene and, in the case of thermosets, phenolic resins. To further reduce friction, these plastics can contain lubricants, in particular finely divided solid lubricants such as polymeric solid lubricants, waxes, molybdenum disulfide, or graphite. Polymers containing such lubricants are also referred to as tribopolymers. Such material pairings of a rail and a slide, which have already been developed and are known in the prior art, make it possible to provide a robust rail on the one hand and, on the other hand, to achieve a low-friction sliding support of the slide on the rail that is as durable as possible, i.e. that hardly changes over a long sliding distance. By dispensing with lubricants, i.e. lubricants that have to be supplied externally to the sliding-bearing assembly, such as oils, environmental pollution and costly maintenance can also be reduced. However, the manufacture of such sliding-bearing assemblies that sufficiently meet the requirements placed on them requires a considerable amount of energy and the use and transport of non-renewable raw materials, which continues to be associated with a not insignificant environmental impact.

The present invention is based on the problem of providing a sliding-bearing assembly or a system comprising a sliding-bearing assembly or a use of a sliding-bearing assembly or materials which at least partially remedy at least one disadvantage of conventional sliding-bearing assemblies.

As a solution to the problem underlying the invention, the invention proposes a sliding-bearing assembly with the features according to claim 1. Such a sliding-bearing assembly according to the invention comprises a slide and a rail, wherein the rail has a cylindrical guide portion, the cylinder axis of which runs in a longitudinal direction. The slide has a passage running along the longitudinal direction for receiving the guide portion of the rail. In an operating state of the sliding-bearing assembly, in which the slide can be moved such that it is slidably guided along the rail in the longitudinal direction, the guide portion is arranged in the passage of the slide and is enclosed by an inner face of the passage, thus fixing the slide in position perpendicularly to the longitudinal direction. In the operating state, the passage encloses the guide portion with its inner face in an interrupted or uninterrupted manner, but in any case to such an extent that the position of the slide perpendicular to the longitudinal direction, in particular in each direction perpendicular to the longitudinal direction, is defined by the enclosing of the guide portion. In general, it is preferred for the slide to rest against the rail exclusively via the inner face of its passage in the operating state. The inner face of the passage preferably refers to the region of the passage which, in the operating state, provides a stop for the guide portion in every direction perpendicular to the longitudinal direction and thereby defines the position of the guide portion relative to the slide perpendicular to the longitudinal direction. The sliding-bearing assembly according to the invention may have features in embodiments as described above with reference to generic sliding-bearing assemblies. The embodiments of the invention described below can be combined with each other in a particularly advantageous manner.

According to the invention, the guide portion is made of wood and the inner face of the passage is made of a sliding plastic, in particular of a tribopolymer. The inventors have surprisingly found that the combination of sliding plastic and wood is a particularly good material combination for the implementation of a sliding-bearing assembly. While in the prior art, wood is generally not considered a reliable sliding partner due to its complex deformation behavior and is used at most in large-area devices in which solid counter components made of metal, in particular bronze or steel, are used as sliding partners and lubricants, such as water or oil, are used in addition to ensure sufficiently good displaceability of the component relative to the wood, the present invention is based on the finding that a sliding-bearing assembly with very good and durable sliding guide properties can be provided by manufacturing the inner face of the passage of the slide from a sliding plastic and the guide portion of the rail from wood. Because during the development of the invention, it was found that the interaction of the sliding plastic with the wood provides tolerance for the deformation tendencies inherent in the wood and that, in addition, the use of the sliding plastic prevents excessive wear in the form of abrasion of the wood, as, surprisingly, the sliding plastic forms a material pairing with the wood, in particular by the wood absorbing plastic abrasion during use of the sliding-bearing assembly, wherein wood has also proven to be sufficiently robust for the implementation of the guide portion of a rail, in particular of a rail as a whole, of a sliding-bearing assembly. The invention thus provides a sliding-bearing assembly that is as sustainable as possible, i.e. environmentally friendly to manufacture, with sufficiently durable guiding and sliding properties.

In one embodiment, the inner face of the passage for fixing the position of the guide portion in a direction perpendicular to the longitudinal direction has two inner face portions facing each other in this direction, between which the guide portion is arranged in the operating state. The aforementioned direction is a specific direction that runs perpendicular to the longitudinal direction. In this direction, it is preferable to provide a play of the guide portion between the inner face portions facing each other in this direction, the amount of which is at least the sum of 0.2 mm as a basic play and 0.5 % of a total extension length of the guide portion in this direction. Reference is made here, of course, to the operating state in which the guide portion is arranged in the passage. The play in the specified direction means that the guide portion can be brought into contact with one of the two inner face portions of the inner face facing each other in this direction and then has a distance to the opposite inner face portion in this direction corresponding to the play. Preferably, the play is at least the sum of 0.2 mm as the base play and 0.8%, in particular 1%, of the total length of the guide portion in this direction. In one embodiment, the total extension length of the guide portion in the specified direction is 20 mm, wherein in this embodiment a play is provided in the operating state the amount of which is the sum of 0.2 mm as the basic play and 1.0% of the total extension length of the guide portion in the specified direction. In the embodiment described, the play is therefore 0.2 mm+0.2 mm=0.4 mm. This is based on the operating condition under specified conditions, for example at a room temperature of 20 °C and a humidity of 60% in room air. The inventors have found that such a play can still be compensated for by the interaction of wood and sliding plastic in such a way that reliable, low-loss, and low-friction guidance of the slide on the rail is ensured. At the same time, the play can counteract deformation of the guide portion. It has been found that it is particularly advantageous for such a play, the amount of which is determined as explained above, to be provided in two different directions in the operating state, each of which is perpendicular to the longitudinal direction and at an angle of 90° to each other. The play of the guide portion between the inner face portions facing each other in a specific direction is thus provided both with reference to a first direction and with reference to a second direction, the first and second directions running perpendicular to the longitudinal direction and at an angle of 90° to each other, as explained. In each of these calculations, the inner face has two opposite inner face portions and a play of the guide portion is provided in the operating state between these opposite inner face portions, the amount of which is at least the sum of 0.2 mm as the basic play and 0.5% of the total extension length of the guide portion in the respective direction.

In one embodiment, the guide portion has, within its region received by the passage in the operating state, an extension length in each direction perpendicular to the longitudinal direction of at least 8 mm, in particular at least 10 mm, in particular at least 15 mm, in particular a maximum of 50 mm, in particular a maximum of 40 mm, in particular a maximum of 30 mm. The region of the guide portion is the entire region of the guide portion with which it extends within the passage in the operating state and is thus enclosed by the inner face of the passage, defining its position relative to the rail perpendicular to the longitudinal direction. Particularly preferably, the guide portion is designed with a cross-section in the form of a circular cylinder, a prism, a dovetail or an exclusively rectangular, in particular square or rectangular cross-section. In one embodiment, the rail is made entirely of wood and has a cross-section perpendicular to the longitudinal direction, which is at least partially T-shaped and thus has a crossbar and a beam running perpendicular to it, wherein the crossbar forms the guide portion that is enclosed by the passage during operation, and the beam extending perpendicular thereto extends out of the passage in the operating state. The crossbar may, for example, be rectangular or rounded. The beam extending perpendicularly thereto may be continuous over the entire longitudinal extent of the rail or may have interruptions. Such a beam running perpendicularly to the crossbar can be advantageous for providing particularly good support for the guide portion over the longitudinal extension of the rail.

In one embodiment, the sliding plastic consists of less than 20 wt. %, in particular less than 10 wt. %, in particular less than 7 wt. %, of petroleum-based plastic. In one embodiment, the sliding plastic consists of at least 90 wt. %, in particular at least 95 wt. %, of recycled plastic. Generally preferred, the inner face of the passage is formed by a component made of plastic that is produced in particular by injection molding. In one embodiment, the slide has a slide body with a continuous opening in the longitudinal direction, in which opening a sliding element made of the sliding plastic is arranged, the sliding element forming the inner face of the passage. The sliding element may, for example, be hollow cylindrical. In one embodiment, the entire slide is made of the sliding plastic. By consisting of less than 20 wt. % petroleum-based plastic and/or at least 90 wt. % recycled plastic, the sliding-bearing assembly can be manufactured in a particularly resource-saving and thus particularly sustainable manner. It has been found that, especially in combination with wood, the sliding plastic can achieve sufficient sliding properties relative to wood even without the use of petroleum-based plastic. In one embodiment, the sliding plastic consists of at least 80 wt. %, in particular at least 90 wt. %, of components made from renewable raw materials. For example, it has proven particularly advantageous to manufacture the sliding plastic from at least 80 % by weight, in particular at least 90 % by weight, of a plastic produced from castor oil or similar oil obtained naturally from plants. Such a sliding plastic has proven to be particularly suitable for pairing with wood, in which case it has been found that even by adding a small proportion of lubricants to such a plastic obtained from renewable raw materials, a sliding plastic can be produced which is suitable for achieving the sliding plastic of a sliding-bearing assembly according to the invention. Preferably, the proportion of lubricants in the sliding plastic is less than 10 wt. %, in particular less than 8 wt. %, in particular less than 6 wt. %. In general, the sliding plastic consists of at least 3 wt. %, in particular at least 4 wt. %, in particular at least 5 wt. % of lubricants. The lubricants particularly preferably include solid lubricants, for example at least one polymeric solid lubricant. Generally preferred, the sliding-bearing assembly as a whole consists of at least 90 wt. %, in particular at least 95 wt. %, in particular at least 98 wt. % recycled plastic and/or renewable raw materials. By using essentially recycled plastic and/or renewable raw materials to manufacture the entire sliding-bearing assembly, the sliding-bearing assembly can be manufactured in a particularly environmentally friendly manner. It has surprisingly been found that, by expertly combining the components of the sliding plastic based on the above-mentioned, particularly advantageous weight ratios, it is possible to produce a sliding plastic for the inner face of the passage which, in combination with a guide portion made of wood, enables a durable, reliable sliding-bearing assembly.

In one embodiment, a load can be applied to the slide in the operating state in a load direction perpendicular to the longitudinal direction, producing a surface pressure between the inner face of the passage of the slide and the guide portion of the rail, wherein the slide, while maintaining the surface pressure, i.e. while being loaded, can be moved in the longitudinal direction relative to the rail along the rail. The load direction preferably corresponds to the specific direction explained above, in particular when the corresponding embodiments are combined. In one embodiment, the sliding-bearing assembly is designed such that the rail has an underside which, with respect to a vertical direction perpendicular to the longitudinal direction, forms one end of the rail, wherein the load direction runs parallel to the vertical direction from top to bottom and the slide is arranged at least in sections above the rail. The sliding-bearing assembly is particularly preferred in the load direction, where it can be subjected to a greater load than in a direction perpendicular to the load direction and to the longitudinal direction. Particularly preferably, a load can be applied to the sliding-bearing assembly in the load direction which is higher than in a direction running perpendicularly to the load direction and to the longitudinal direction. Particularly preferably, the sliding-bearing assembly is used in that a load acts on the slide of the sliding-bearing assembly in the load direction while the rail is held in a fixed position.

Particularly preferably, the sliding-bearing assembly is designed such that, in the operating state, the slide can move along the rail in the longitudinal direction relative to the rail while it is loaded with a load as explained, which exerts a force on the slide in the load direction and thus on the slide relative to the rail in the load direction, of at least 200 N, wherein, preferably, when the slide moves relative to the rail in a longitudinal direction at a speed of 0.1 m/s, the coefficient of friction is less than 0.4, in particular less than 0.3, in particular less than 0.25. It has been found in this context that such suitability of the sliding-bearing assembly can be achieved by expert selection of the surface with which the inner face presses against the guide portion of the rail in the operating state, together with the sliding pairing of wood and sliding plastic. In addition, such a suitability can be ensured by the rail having several guide portions and the slide having several passages, as explained in more detail below. It is particularly preferred for the sliding-bearing assembly to be configured in such a way that, when a load of 50 N is applied to the slide in the load direction relative to the rail, the slide, starting from an initial position in which the sliding-bearing assembly is in the operating state, is movable in the longitudinal direction relative to the rail over a travel distance of at least 100 km, in particular at least 500 km, and any play which is present between the guide portion and the inner face of the passage in the initial state until the end of the travel distance increases to less than 200%, in particular less than 150%, of its value present in the initial state. It should be noted that the travel distance indicates the total length of the distance in the longitudinal direction over which the slide is moved relative to the rail. Accordingly, the travel distance has a beginning and an end. At the beginning of the travel distance, the sliding-bearing assembly is in the initial state, and at the end of the travel distance, it is in the end state, wherein it is in the operating state in both the initial state and the end state. The initial state and end state differ only in that the travel distance between the initial state and the end state has been passed. By designing the sliding-bearing assembly in such a way that the play hardly changes despite the slide being loaded over a correspondingly long travel distance, a durable and reliable functionality of the sliding-bearing assembly can be ensured. For this purpose, an expertly selected geometry of the guide portion or rail and the inner face or slide is chosen, in particular in combination with the advantageous properties of the sliding plastic described above. As explained above, the play is defined with reference to a specific direction perpendicular to the longitudinal direction. Particularly preferably, the sliding-bearing assembly is designed in such a way that the slide, when loaded with a load that causes a surface pressure of 0.4 MPa between the inner face and the guide portion, is movable in the longitudinal direction relative to the rail starting from the initial state over a travel distance of at least 100 km, in particular at least 500 km, and that any play between the guide portion and the inner face of the passage at the initial state increases to less than 200 %, in particular less than 150 %, of its value in the initial state until the end of the travel distance.

It is particularly preferred that the slide, in the operating state, can be loaded in the load direction with a load producing a value for the surface pressure of 0.4 MPa and can be moved relative to the rail at a speed of 0.1 m/s with a sliding friction coefficient of less than 0.4, in particular less than 0.3, in particular less than 0.25, without lubricant. It is particularly preferred that slide, in the operating state, can be loaded in the load direction with a load producing a value for the surface pressure of 0.2 MPa and can be moved in the longitudinal direction relative to the rail at a speed of 0.3 m/s with a sliding friction coefficient of less than 0.2, in particular less than 0.15, without lubricant. It is particularly preferred that the slide, in the operating state, can be loaded in the load direction with a load producing a value for the surface pressure of 1.0 MPa and can be moved in the longitudinal direction relative to the rail at a speed of 0.2 m/s with a sliding friction coefficient of less than 0.4, in particular less than 0.3, in particular less than 0.25, without lubricant. It has been found that both a cost-effective production of the sliding plastic is made possible and a long service life of the sliding-bearing assembly is ensured due to the expert design of the geometries of the passage and guide portion, in particular by providing a surface across which the inner face of the passage and the guide portion bear against each other in the operating state under a load in the load direction such that a surface pressure as explained is to be expected and a corresponding coefficient of friction is set in the specified range at this surface pressure.

In particular, the sliding-bearing assembly has proven to be particularly advantageous for use in such a load range, in which a surface pressure between the inner face and the guide portion of less than 1.5 MPa, in particular less than 1.0 MPa, in particular less than 0.7 MPa, in particular less than 0.5 MPa, in particular less than 0.4 MPa, is ensured. The inventors have recognized that a sustainable sliding-bearing assembly according to the invention can be used particularly advantageously and with particularly long-lasting properties in such a range of surface pressure. Furthermore, the inventors have recognized that the friction coefficients described for the sliding speeds described at the surface pressures described can be achieved particularly advantageously and easily by the provision of proportions of the sliding plastic described herein, in particular also by using a considerable proportion of recycled plastic and/or plastic obtained from renewable raw materials.

Particularly preferably, the sliding-bearing assembly configured such that, in the operating state, the slide can be loaded in the load direction with a load producing a value for the surface pressure of 0.1 MPa and can be moved in the longitudinal direction relative to the rail at an average speed of 0.18 m/s and a maximum speed of 0.3 m/s throughout a total distance of 500 km at a wear value of less than 0.3 μm/km. The wear value indicates the amount of material removed from the inside of the passage. The wear value can be determined, for example, by measuring the passage at the beginning and end of the total distance. It is particularly preferred that the total distance is traveled by moving the carriage back and forth relative to the rail in strokes, each stroke covering a distance of at least 30 cm, preferably 40 cm, i.e. the carriage is moved in the longitudinal direction relative to the rail over a distance of 40 cm per stroke. At the beginning and end of each stroke, the speed of the slide is reduced to zero and the direction of movement of the slide is reversed. It is particularly preferred that the slide is moved relative to the rail in such a way that it reaches its maximum speed in the middle between the beginning and end of each stroke. Preferably, the slide is accelerated linearly from the start and end of each stroke to reach the maximum speed and then decelerated linearly so that there is uniform acceleration and deceleration from the start and end of the stroke until the maximum speed is reached or starting from the maximum speed. The preferred embodiment described above, in which the play increases to less than 200% at a surface pressure of 0.4 MPa over a travel distance of at least 100 km, is suitable for ensuring this low increase in play during such a travel distance as described above with reference to strokes and speed. The design of the sliding plastic and the geometry of the inner face and guide portion, which must be expertly selected in order to achieve this suitability of the sliding-bearing assembly, has proven to be particularly advantageous, as this provides a resource-saving sliding-bearing assembly that is durable and reliable for a wide range of applications.

In one embodiment, the rail has several cylindrical guide portions and the slide has several passages. Each of the guide portions is assigned to precisely one of the passages. The guide portion and the assigned passage can be designed as explained above with reference to a guide portion and a passage. For example, the cylinder axes of all guide portions preferably run in the longitudinal direction. In the operating state, in the advantageous embodiment of the sliding-bearing assembly described, each of the guide portions is arranged in one of the passages of the slide assigned to it and is enclosed by the inner face of the passage assigned to it whilst fixing the position of the slide perpendicular to the longitudinal direction. Preferably, all guide portions are made of wood and the inner faces of all passages are made of its sliding plastic. It is particularly preferred that all guide portions have the same cross-section. It is particularly preferred that, in the operating state, the contact surface across which one of the guide portions rests against the passage assigned to it is identical for each pair of guide portions and assigned passages, especially when a load acts on the slide in the load direction. It is particularly preferred that the rail has precisely two guide portions and that the slide has precisely two passages. It is particularly preferred for the guide portions to be spaced apart from each other in a transverse direction perpendicular to the longitudinal direction, the transverse direction being perpendicular to a vertical direction, wherein, in intended use, the rail is fastened with its underside, which forms one end of the rail with respect to the vertical direction, to a component, such as a component of a machine or a piece of furniture or a floor and a wall. Particularly preferably, the rail has a rail body that connects the multiple guide portions to each other in a positionally fixed manner. Accordingly, all guide portions are fixed in position on the rail body. Particularly preferably, the entire rail is made of wood. The entire rail is particularly preferably made in one piece.

In one embodiment, the rail has a rail body that extends over at least 80% of the longitudinal extension length of the guide portion and is fastened to the guide portion. The rail body has a higher rigidity in a load direction perpendicular to the longitudinal direction than the guide portion and is spaced apart from the inside of the passage in the operating state. For example, the guide portion can be formed by the crossbar described above with reference to an embodiment, and the rail body can form the beam extending perpendicular thereto. Preferably, the load direction is identical to the load direction described above, in particular in correspondingly combined advantageous embodiments. The rail body can extend continuously or discontinuously across its longitudinal extension length, which is at least 80% of the longitudinal extent of the guide portion, in particular identical to the longitudinal extension length of the guide portion.

The invention also relates to a system comprising a sliding-bearing assembly according to the invention. The system comprises a first component fixed to the carriage and a second component fixed to the rail. The two components are preferably fixed in their relative position perpendicularly to the longitudinal direction solely by the sliding-bearing assembly. The two components are guided so that they can move relative to each other in the longitudinal direction via the sliding-bearing assembly. In one embodiment, the system is a piece of furniture and the components are furniture parts, with the furniture components being made of wood or recycled plastic in a particularly preferred embodiment. In one embodiment, the system is a machine, in particular a transport machine, and the components are machine components, wherein the machine components are preferably made of wood or recycled plastic. A transport machine is a machine the intended use of which is based on the movement of the two components in the longitudinal direction relative to each other. The system is particularly preferred to be designed in such a way that the described loads of the slide relative to the rail, in particular with regard to the advantageously set load acting in the load direction, are ensured. Particularly preferably, in a normal operating state of the system in which the sliding-bearing assembly is in its operating state, the components press against each other in a direction perpendicular to the longitudinal direction via the sliding-bearing assembly with a force producing a surface pressure between each guide portion of the rail and the inner face of the passage assigned to it, the value of which is less than 1.5 MPa, in particular less than 1.0 MPa, in particular less than 0.5 MPa. Preferably, the surface pressure is at least 0.1 MPa. If only one guide portion and only one passage are provided, the value of course refers to the surface pressure between the said one guide portion and the inside of the said one passage. Preferably, the direction mentioned corresponds to the load direction mentioned above. The system, in which the slide is intended to move relative to the rail in the longitudinal direction, is used as intended in such a way that a surface pressure defined by the properties of the system is established between the guide portion and the inner face of the passage assigned to it. The inventors have recognized that the sliding-bearing assembly according to the invention can be used particularly advantageously in such a system according to the invention. The system is particularly preferably configured in such a way that the slide can be moved relative to the rail over a length in the longitudinal direction of at least 30 cm, in particular at least 50 cm, in particular 1 m, by means of the sliding-bearing assembly and is thus guided and mounted on the rail over this distance. Stops are particularly preferred for limiting the length to less than 2 m, in particular less than 1 m, in particular less than 50 cm.

The invention also relates to the use of a sliding-bearing assembly for moving a first component relative to a second component along a longitudinal direction free of lubricant. Free of lubricant means that no external lubricant is supplied to the sliding-bearing assembly during this movement, but rather that the rail and the slide slide “dry” along each other, i.e. directly adjacent to each other and without any lubricant provided between them. The sliding-bearing assembly comprises a slide and a rail. The first component is fixed to the slide and the second component is fixed to the rail. The rail has a cylindrical guide portion whose cylinder axis runs in the longitudinal direction. The slide has a passage running along the longitudinal direction for receiving the guide portion of the rail. To ensure that the first component moves in the longitudinal direction relative to the second component, the guide portion is arranged in the passage of the slide so that it is enclosed by an inner face of the passage, thereby fixing the position of the slide perpendicular to the longitudinal direction. According to the invention, a wooden rod is used as the guide portion, in particular as the rail as a whole. According to the invention, the inner face of the passage, with which the passage bears against the guide portion during longitudinal movement of the first component relative to the second component, is made of a sliding plastic, in particular of a tribopolymer. Beech, birch, maple, oak, ash, spruce, pine, larch or nut wood are particularly preferred as wood. The use according to the invention may have features in embodiments thereof that are described in embodiments of the sliding-bearing assembly according to the invention or of the system according to the invention. Accordingly, the sliding-bearing assembly according to the invention may have features that are described here in connection with embodiments of a use according to the invention. This applies to any use described herein. In one embodiment, the sliding-bearing assembly is used for moving the first component relative to the second component in the longitudinal direction over a distance in the longitudinal direction of at least 5 km, in particular at least 10 km, in particular at least 50 km, in particular at least 100 km. In one embodiment, the sliding-bearing assembly is used for the guided movement of the first component relative to the second component in the longitudinal direction with a surface pressure acting between the guide portion and the inner face of the passage perpendicular to the longitudinal direction, in particular with a surface pressure acting in the load direction, of at least 0.1 MPa, in particular at least 0.2 MPa, in particular less than 1.5 MPa, in particular less than 1.0 MPa, is used.

The invention also relates to the use of a sliding plastic for forming an inner face of a passage of a slide and the use of the slide for forming a sliding-bearing assembly which has the slide and a rail with a wooden rod extending in a longitudinal direction as a guide portion of the rail, wherein, in an operating state of the sliding-bearing assembly, the slide is movable in a sliding manner in the longitudinal direction on the rail and the guide portion is arranged in the passage of the slide and is enclosed by the inner face of the passage, fixing a position of the slide perpendicular to the longitudinal direction. As stated, this use may also have features that are described here in connection with a sliding-bearing assembly according to the invention or with other embodiments of a use according to the invention. The invention is based on the particular finding that the use of a sliding plastic for the inner face of the passage of the slide and the use of a wooden rod as the guide portion of the rail for the implementation of a sliding-bearing assembly, as described above, is particularly advantageous.

The invention will be explained in more detail below with reference to three drawing figures based on execution examples.

In the figures it is shown by:

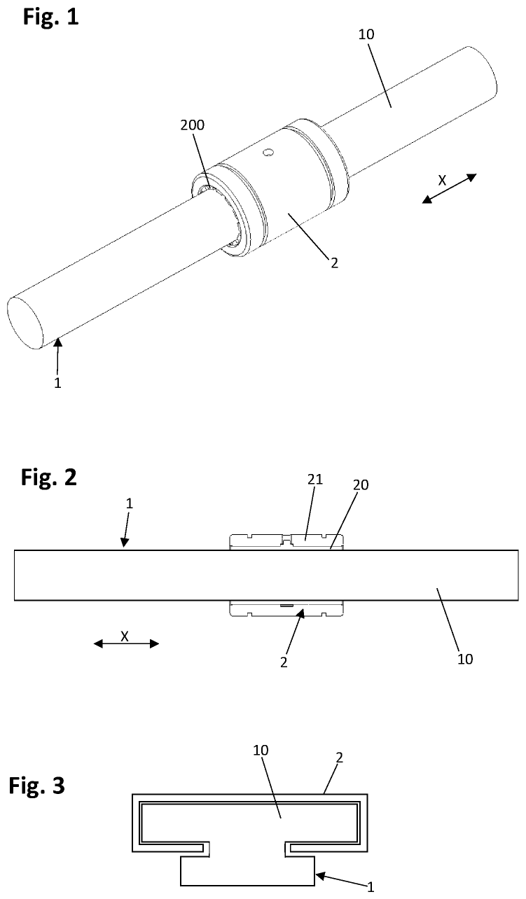

FIG. 1: a schematic diagram of a first embodiment of a sliding-bearing assembly according to the invention;

FIG. 2: a schematic diagram of a cross-section through the sliding-bearing assembly according to FIG. 1 along the longitudinal direction;

FIG. 3: a schematic diagram showing a cross-section perpendicular to the longitudinal direction of a further embodiment of a sliding-bearing assembly according to the invention.

FIG. 1 shows an embodiment of a sliding-bearing assembly according to the invention in its operating state. The sliding-bearing assembly has a rail 1 and a slide 2. The slide 2 has a passage in which the guide portion 10 of the rail 1 is arranged in the operating state. In the present embodiment, the rail 1 is formed by the guide portion 10, which is designed as a straight, circular cylinder. The slide 2 has a metal sleeve 21 and a sliding element 20, which is inserted into the metal sleeve 21 and forms the inner face of the passage of the slide 2, which surrounds the guide portion 10 of the rail 1. In the present case, the inner face is formed by the side of the projections 200 of the sliding element 20, which side faces the guide portion 10 radially, i.e. in a direction perpendicular to the longitudinal direction X. In each movement of the guide portion perpendicular to the longitudinal direction X relative to the slide 2, the guide portion 10 can only move until it comes into contact with an inner face portion of the inner face of the passage. Thus, the guide portion 10 is reliably guided perpendicular to the longitudinal direction in the passage of the slide 2, while the slide 2 is movable relative to the rail 1 in the longitudinal direction X, sliding along the latter. In the present case, the entire rail, i.e. also the guide portion 10, is made of wood, whereas the sliding element 2, which forms the inner face of the passage, is made of a sliding plastic by injection molding, which sliding plastic is made of 94% renewable raw materials and contains 6% solid lubricants, in this case waxes and polymeric solid lubricants. The renewable raw material is a vegetable oil from which the plastic was produced that was used as plastic granulate to produce the sliding element 20.

FIG. 2 shows that the guide portion 10, in the operating state, is held in the passage of the slide 2 with very little play, in this case 0.5 mm, in the direction perpendicular to the longitudinal direction X lying in the plane of FIG. 2. The guide portion has a diameter of 20 mm. The projections 200 also ensure particularly friction-free guidance of the guide portion in the passage of the slide 2, since, on the one hand, the projections adjust the contact surface of the inner face and guide portion to a reasonable dimension and, on the other hand, are arranged evenly around the guide portion and also have spaces between them for collecting contaminants.

FIG. 3 shows a further embodiment of a sliding-bearing assembly according to the invention with its cross-section perpendicular to the longitudinal direction X in a schematic diagram. This embodiment differs from the embodiments shown in FIGS. 1 and 2 essentially in that the slide 2 is made entirely of sliding plastic and the rail 1 has a cross-section perpendicular to the longitudinal direction which is T-shaped in sections, wherein a crossbar of the T-shape forms the guide portion 10 and a beam of the T-shape extending perpendicular to this crossbar extends out of the passage of the slide 2. The rail 1 has a cross-section perpendicular to the longitudinal direction X in the manner of an H-shape, of which only one section is formed in the manner of a T-shape, wherein the region of the cross-section of the rail 1 lying outside the T-shape forms the underside of the rail 1 with which it can be mounted to a component. The load direction in which the sliding-bearing assembly is to be loaded as intended according to FIG. 3 is, in the present case, the vertical direction with reference to which the underside of the rail 1 forms one end of the rail. In further embodiments not shown, the rail 1 may have a cross-section which is at least partially T-shaped, wherein the crossbar is rounded, for example in the manner of an oval or circular section, and extends in the transverse direction over a greater distance than the further beam of the T-shape projecting perpendicularly therefrom.

### LIST OF REFERENCE SIGNS

1 rail
2 slide
10 guide portion
20 sliding element
21 metal sleeve
200 projection

1. A sliding-bearing assembly comprising a slide and a rail, wherein the rail as a cylindrical guide portion, a cylinder axis of which runs in a longitudinal direction, and wherein the slide has a passage running in the longitudinal direction for receiving the guide portion of the rail, wherein in an operating state of the sliding-bearing assembly, in which the slide can be moved such that it is slidably guided along the rail in the longitudinal direction, the guide portion is arranged in the passage of slide and is enclosed by an inner face of the passage, thus fixing the slide perpendicularly to the longitudinal direction, wherein in the operating state, the slide rests against the rail exclusively via the inner face of its passage, so that the inner face of the slide forms the surface of the slide which corresponds to the rail and which rests on the rail during a movement of the slide,
wherein the guide portion is made of wood and the inner side of the passage is made of a sliding plastic which consists of at least 3 wt. % of lubricants, wherein, in the operating state, the slide can be loaded with a load in a load direction perpendicular to the longitudinal direction, producing a surface pressure between the inner face and the guide portion and, while maintaining the surface pressure in the longitudinal direction relative to the rail, can be moved along the rail in a sliding manner, wherein, in the operating state, the slide
can be loaded in the load direction with a load producing a value for the surface pressure of 0.4 MPa and, without the addition of external lubricant, can be moved directly bearing against the rail in the longitudinal direction relative to the rail at a speed of 0.1 m/s with a sliding coefficient of friction of less than 0.4,
can be loaded in the load direction with a load producing a value for the surface pressure 0.2 MPa and, without the addition of external lubricant, can be moved directly bearing against the rail in the longitudinal direction relative to the rail at a speed of 0.3 m/s with a sliding friction coefficient of less than 0.2, and/or
can be loaded in the load direction with a load producing a value for the surface pressure of 1.0 MPa and, without the addition of external lubricant, can be moved directly bearing against the rail in the longitudinal direction relative to the rail at a speed of 0.2 m/s with a sliding friction coefficient of less than 0.4.

2. The sliding-bearing assembly according to claim 1, wherein the inner face of the passage for fixing the position of the guide portion in a direction perpendicular to the longitudinal direction has two inner face portions opposite each other in this direction, between which the guide portion is arranged in the operating state, wherein in this direction a play of the guide portion is provided between the opposite inner face portions, the amount of which is at least as large as the sum of 0.2 mm as a basic play and 0.5% of a total extension length of the guide portion in this direction, wherein such a play of the guide portion in the operating state is provided in two different directions, which are each perpendicular to the longitudinal direction and form an angle of 90° with each other, between inner face portions facing each other in the respective direction.

3. The sliding-bearing assembly according to claim 1, wherein the guide portion has within its region received by the passage in the operating state an extension length in each direction perpendicular to the longitudinal direction of at least 8 mm and most 50 mm.

4. The sliding-bearing assembly according to claim 1, wherein the sliding plastic consists to less than 20 wt. % of petroleum-based plastic and/or consists to at least 90 wt. % of recycled plastic.

5. The sliding-bearing assembly according to claim 1, wherein the sliding-bearing assembly as a whole is made of at least 95 wt. % of recycled plastic and/or renewable raw materials.

6. The sliding-bearing assembly according to claim 1, wherein the lubricants comprise solid lubricants, in particular at least one polymeric solid lubricant.

7. The sliding-bearing assembly according to claim 1, wherein the load has a force on the slide in the load direction of at least up to 200 N and/or the slide, when loaded with a load of 50 N starting from an initial state, can be moved over a movement distance of at least 100 km, in particular at least 500 km in the longitudinal direction relative to the rail, and in this case any play existing between the guide portion and the inner face of the passage in the initial state until the end of the movement distance increases to less than 200% of its value present in the initial state.

8. The sliding-bearing assembly according to claim 7, wherein in the operating state, the slide can be loaded in the load direction with a load producing a surface pressure value of 0.1 MPa and in this case can be moved free of lubricant in the longitudinal direction relative to the rail at an average speed of 0.18 m/s and a maximum speed of 0.3 m/s across a total distance of 500 km with a wear value of less than 0.3 μm/km, wherein the wear value indicates material removal on the inner face of the passage.

9. The sliding-bearing assembly according to claim 1, wherein the rail has several cylindrical guide portions and the slide has several passages, wherein, in the operating state of the sliding-bearing assembly, each of the guide portions is arranged in a respective one of the passages of the slide assigned to it and is enclosed by the inner face of the passage assigned to it, thus fixing the position of the slide perpendicularly to the longitudinal direction, wherein all guide portions are made of wood and the inner faces of all passages are made of the sliding plastic.

10. The sliding-bearing assembly according to claim 1, wherein the rail has a rail body which extends over at least 80% of the longitudinal extension length of the guide portion and is fastened thereto, wherein the rail body has a higher rigidity than the guide portion in a load direction which runs perpendicular to the longitudinal direction and is spaced apart from the inner face of the passage in the operating state.

11. A system comprising:
a sliding-bearing assembly according to claim 1;
a first component fixed to the slide; and
a second component fixed to the rail,
wherein the two components are fixed in their relative position perpendicularly to the longitudinal direction exclusively by the sliding-bearing assembly and are movable relative to each other in the longitudinal direction, wherein the system is a piece of furniture and the components are furniture components or the system is a machine and the components are machine components.

12. The system according to claim 11, wherein in a normal operating state of the system, the components press against each other in a direction perpendicular to the longitudinal direction with a force via the sliding-bearing assembly, producing a surface pressure between any guide portion of the rail and the inner face of the passage assigned to it, which is a value of less than 1.5 MPa and at least 0.1 MPa.

13. A use of a sliding-bearing assembly for guided movement of a first component relative to a second component along a longitudinal direction free of lubricant, wherein the sliding-bearing assembly comprises a slide and a rail and the first component is fixed to the slide and the second component is fixed to the rail, wherein the rail has a cylindrical guide portion the cylinder axis of which extends in the longitudinal direction, and the slide has a passage extending along the longitudinal direction for receiving the guide portion of the rail, wherein, in order to ensure the movement of the first component relative to the second component in the longitudinal direction, the guide portion is arranged in the passage of the slide so that it is enclosed by an inner face of the passage, thus fixing a position of the slide perpendicular to the longitudinal direction and resting on the rail exclusively via the inner face of its passage, so that the inner face of the passage of the slide forms the surface of the slide corresponding to the rail and resting on the rail during movement of the slide,
wherein a wooden rod is used as the guide portion and the inner face of the passage, with which the passage bears against the guide portion during the movement of the first component relative to the second component in the longitudinal direction, is made of a sliding plastic, which consists to at least 3 wt. % of lubricants, wherein the slide is loaded with a load in a load direction perpendicular to the longitudinal direction, producing a surface pressure between the inner face and the guide portion, and is moved along the rail in the longitudinal direction relative to the rail while maintaining the surface pressure, without external lubricants being supplied.

14. The use according to claim 13, wherein the sliding-bearing assembly is used for moving the first component relative to the second component in the longitudinal direction over a distance in the longitudinal direction of at least 5 km and/or for moving the first component relative to the second component in the longitudinal direction with a surface pressure acting between the guide portion and the inner face of the passage perpendicularly to the longitudinal direction of at least 0.1 MPa and less than 1.5 MPa.

15. A use of a sliding plastic for implementing an inner face of a passage of a slide and use of the slide to achieve a sliding-bearing assembly according to claim 1.
